(19) United States
(12) Patent Application Publication
(10) Pub. No.: US 2026/0181396 A1
(43) Pub. Date: Jun. 25, 2026

(54) METHOD, DEVICE AND COMPUTER-READADABLE MEDIUM FOR COMMUNICATION

(71) Applicant: Nokia Technologies Oy, Espoo (FI)

(72) Inventors: Jianguo LIU, Shanghai (CN); Zhijie YANG, Shanghai (CN); Orhan Okan MUTGAN, Munich (DE); Tao TAO, Shanghai (CN); Yan MENG, Shanghai (CN)

(21) Appl. No.: 19/125,678

(22) PCT Filed: Nov. 1, 2022
(86) PCT No.: PCT/CN2022/129104

§ 371 Date: Apr. 29, 2025

(51) Int. Cl. H04W 12/69; H04L 5/00; H04W 12/0431; H04W 60/04

(52) U.S. Cl. CPC H04W 12/69; H04L 5/0053; H04W 12/0431; H04W 60/04

(57) ABSTRACT

Example embodiments of the present disclosure relate to methods, devices, and a computer-readable medium to synchronize change of identifier for device identification. In an example method, a first device determines a set of parameters for identification information generation for the first device, the set of parameters being common to the first device and the second device. The first device generates, based on the set of parameters, first identification information and second identification information of the first device. The first device transmits, to the second device, a first transmission comprising the first identification information. The first device detects a second transmission from the second device using the first identification information and the second identification information. In this way, the first device can be prevented from being tracked, and the signaling overhead can be decreased. Meanwhile, compared with conventional solutions, less implementation complexity and storage can be achieved.

### FIELD

Example embodiments of the present disclosure generally relate to the field of telecommunication, and in particular, to methods, devices, and a computer-readable medium for communication to enhance privacy for IEEE 802.11 in an extended service set (ESS) network.

### BACKGROUND

In conventional IEEE 802.11 standards, the stations (STAs) use the fixed unencrypted medium access control (MAC) address in frame headers, which causes a security concern by allowing others to track STAs based on their MAC addresses. Here “Station” refers to a device which serves as a terminal, instead of an access point (AP) serving as a network device in a wireless network, for example, in an ESS network. To prevent the STA from being tracked and improve the privacy of IEEE 802.11, IEEE 802.11bh and 802.11bi groups focus on identification of STAs using random MAC address (RMA) without decreasing user privacy. IEEE 802.11bh and 802.11bi focuses on STA privacy protection through RMA in pre-association phase, while an STA still doesn't change MAC address after association (i.e., in post-association phase).

### SUMMARY

In general, example embodiments of the present disclosure provide methods, devices, and a computer-readable medium for communication, for example, to enhance privacy for IEEE 802.11bi and 802.11bh in an ESS network, especially to enhance randomized and changing MAC address (RCM) for STA device identification.

In a first aspect, there is provided a first device. The first device comprises at least one processor and at least one memory storing instructions that, when executed by the at least one processor, cause the first device to: determine a set of parameters for identification information generation for the first device, the set of parameters being common to the first device and the second device; generate, based on the set of parameters, first identification information and second identification information of the first device; transmit, to the second device, a first transmission comprising the first identification information; and detect a second transmission from the second device using the first identification information and the second identification information. The first device may be a STA device or an AP device in an ESS network.

In a second aspect, there is provided a second device. The second device comprises at least one processor; and at least one memory storing instructions that, when executed by the at least one processor, cause the second device to: determine a set of parameters for identification information generation for a first device, the set of parameters being common to the first device and the second device; generate, based on the set of parameters, third identification information and fourth identification information of the first device; detect a first transmission from the first device using the third identification information and the fourth identification information; and transmit, to the first device, a second transmission comprising the third identification information. The second device may be an AP device or STA device in an ESS network.

In a third aspect, there is provided a method implemented in a first device according to the first aspect. The method comprises: determining, at a first device, a set of parameters for identification information generation for the first device, the set of parameters being common to the first device and the second device; generating, based on the set of parameters, first identification information and second identification information of the first device; transmitting, to the second device, a first transmission comprising the first identification information; and detecting a second transmission from the second device using the first identification information and the second identification information.

In a fourth aspect, there is provided a method implemented at a second device according to the second aspect. The method comprises: determining, at a second device, a set of parameters for identification information generation for a first device, the set of parameters being common to the first device and the second device; generating, based on the set of parameters, third identification information and fourth identification information of the first device; detecting a first transmission from the first device using the third identification information and the fourth identification information; and transmitting, to the first device, a second transmission comprising the third identification information.

In a fifth aspect, there is provided an apparatus implemented in a first device according to the first aspect. The apparatus comprises: means for determining, at a first device, a set of parameters for identification information generation for the first device, the set of parameters being common to the first device and the second device; means for generating, based on the set of parameters, first identification information and second identification information of the first device; means for transmitting, to the second device, a first transmission comprising the first identification information; and means for detecting a second transmission from the second device using the first identification information and the second identification information.

In a sixth aspect, there is provided an apparatus implemented in a second device according to the second aspect. The apparatus comprises: means for determining, at a second device, a set of parameters for identification information generation for a first device, the set of parameters being common to the first device and the second device; means for generating, based on the set of parameters, third identification information and fourth identification information of the first device; means for detecting a first transmission from the first device using the third identification information and the fourth identification information; and means for transmitting, to the first device, a second transmission comprising the third identification information.

In a seventh aspect, there is provided a non-transitory computer-readable storage medium having instructions stored thereon. The instructions, when executed on at least one processor, cause the least one processor to perform the method of any of the third or fourth aspects.

In an eighth aspect, there is provided a computer program comprising instructions, which, when executed by an apparatus, cause the apparatus at least to: determine a set of parameters for identification information generation for the first device, the set of parameters being common to the first device and the second device; generate, based on the set of parameters, first identification information and second identification information of the first device; transmit, to the second device, a first transmission comprising the first identification information; and detect a second transmission from the second device using the first identification information and the second identification information.

In an ninth aspect, there is provided a computer program comprising instructions, which, when executed by an apparatus, cause the apparatus at least to: determine a set of parameters for identification information generation for a first device, the set of parameters being common to the first device and the second device; generate, based on the set of parameters, third identification information and fourth identification information of the first device; detect a first transmission from the first device using the third identification information and the fourth identification information; and transmit, to the first device, a second transmission comprising the third identification information.

In a tenth aspect, there is provided a first device according to the first aspect. The first device comprises: determining circuitry configured to determine a set of parameters for identification information generation for a first device, the set of parameters being common to the first device and the second device; generating circuitry configured to generate, based on the set of parameters, third identification information and fourth identification information of the first device; detecting circuitry configured to detect a first transmission from the first device using the third identification information and the fourth identification information; and transmitting circuitry configured to transmit, to the first device, a second transmission comprising the third identification information. The first device may be a STA device or an AP device in an ESS network.

In an eleventh aspect, there is provided a second device according to the second aspect. The second device comprises: determining circuitry configured to determine a set of parameters for identification information generation for a first device, the set of parameters being common to the first device and the second device; generating circuitry configured to generate, based on the set of parameters, third identification information and fourth identification information of the first device; detecting circuitry configured to detect a first transmission from the first device using the third identification information and the fourth identification information; and transmitting circuitry configured to transmit, to the first device, a second transmission comprising the third identification information. The second device may be an AP device or a STA device in an ESS network.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example of a network environment in which some example embodiments of the present disclosure may be implemented;

FIG. 2 illustrates a flowchart illustrating a communication process in accordance with some example embodiments of the present disclosure;

FIG. 3A illustrates another flowchart illustrating another communication process in accordance with some example embodiments of the present disclosure;

FIG. 3B illustrates another flowchart illustrating another communication process in accordance with some example embodiments of the present disclosure;

FIG. 4 illustrates an example process of frame transmission in accordance with some example embodiments of the present disclosure;

FIG. 5 illustrates a flowchart of an example method implemented at a first device in accordance with some embodiments of the present disclosure;

FIG. 6 illustrates another flowchart of an example method implemented at a second device in accordance with some embodiments of the present disclosure; and

FIG. 7 illustrates a simplified block diagram of a device that is suitable for implementing some example embodiments of the present disclosure; and

FIG. 8 illustrates a block diagram of an example of a computer-readable medium in accordance with some example embodiments of the present disclosure.

Throughout the drawings, the same or similar reference numerals represent the same or similar elements.

Through this document, the terms defined below may be referenced.

| | |
|---|---|
| ACK | acknowledgement |
| AP | access point |
| ESS | extended service set |
| EAPOL | extensible authentication protocol over LAN |
| ID | identifier |
| IoT | Internet of Things |
| MAC | medium access control |
| RCM | randomized and changing MAC address |
| RMA | random MAC address |
| STA | station |

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), Wireless Fidelity (WiFi) and so on. Furthermore, the communications between a terminal device and a network device in the communication network may be performed according to any suitable generation communication protocols, including, but not limited to, the fourth generation (4G), 4.5G, the future fifth generation (5G), IEEE 802.11 communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a WiFi device, a relay, a low power node such as a femto, a pico, and so forth, depending on the applied terminology and technology. In the following description, the terms “network device”, “AP device”, “AP” and “access point” may be used interchangeably.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), a station (STA) or station device, or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “station”, “station device”, “STA”, “terminal device”, “communication device”, “terminal”, “user equipment” and “UE” may be used interchangeably.

As mentioned above, in conventional IEEE 802.11 standards, the STAs use the fixed unencrypted MAC address in frame headers, which causes a security concern by allowing others to track STAs based on their MAC addresses. To prevent the STA from being tracked and improve (or enhance) the privacy of 802.11, IEEE 802.11bh and 802.11bi groups focus on identification of STAs using RMA. IEEE 802.11bh and 802.11bi focuses on STA privacy protection through RMA in pre-association phase, while an STA still doesn't change MAC address after association (i.e., at post-association phase).

Specifically, IEEE 802.11bh proposed to assign one or more device identification information (e.g., ID or RMA) for communication between STA and AP in one association (e.g., first association), and use at least one of them in later association(s) (e.g., second association). However, when the STA is assigned a small amount of device identification information, the STA needs to change device identification information frequently to prevent itself from being tracked. This frequent change of device identification information would cause additional power consumption and communication overhead, which is not friendly to low-cost/power or/and non-authentication terminal device (e.g., IoT device). On the other hand, when the STA is assigned a large amount of device identification information, both the AP and STA have to process/store a lot of information and detect the transmission from the other side for device identification, thus the implementation complexity and power consumption at the AP and STA will increase as the amount of device identification information increases.

IEEE 802.11bi proposed to rotate MAC address of STA over the air solution to address this issue. However, MAC address rotation potentially requires a non-AP STA to often dis-associate/re-associate to change its MAC, and these frequent attempts to change MAC address may lead to degradation of user experience and increase of the management frame overhead. IEEE 802.11bh/bi is referred to here just for illustrative purpose; the communication protocol to which the solution proposed herein can be applied is not limited to IEEE 802.11bh/bi. Rather, any other communication protocol to which the solution proposed herein can be applied falls into the scope of this disclosure.

In this disclosure, a solution is introduced to synchronize the change of STA's identifier at both the AP and STA based on frame transmission acknowledgment (ACK) mechanism in pre-association phase or/and post-association phase, which benefits privacy protection of the STA with low implementation complexity and signaling overhead. What's more, the proposed solution can be applied in pre-association and/or post-association. Therefore, even at the post-association phase, STA's identifier can be changed with low implementation complexity and signaling overhead, thus the risk of the STA being tracked can be decreased and privacy is protected.

This disclosure is proposed to randomize and change identifier of the STA. The basic idea of this disclosure is that an AP and an STA can negotiate and determine at least a shared rule for identifier (e.g., RMA or ID) generation/change, a secret key, and a counter. After that, the AP and the STA would respectively determine and maintain at least two identifiers used for device identification of the STA in subsequent frame transmission and reception, and change the identifier based on acknowledgement (ACK). As for the determination of the identifiers, in one example, either of the AP and the STA may determine a first STA/AP-decided identifier at least based on the shared rule, the secret key, and the counter at local. In another example, the AP may generate a second AP-decided identifier at least based on the shared rule, the secret key, and the counter at local minus 1. In another example, the STA generates a second STA-decided identifier at least based on the shared rule, the secret key, and the counter at local plus 1.

In addition, the AP and the STA transmit new frame using their first identifier and receives frame transmission at least using their first and second identifiers for device identification of the STA, respectively. As an example, the identifier information can be an RMA carried in the MAC header of the frame transmission. As another example, the identifier information may be any information used for device identification (e.g., device ID) other than the RMA. In this case, either of the AP and the STA needs to indicate the identifier information in the frame transmission, e.g., through MAC header of the frame transmission or a new IE in the frame transmission.

The STA and the AP may change the identifier of the STA based on acknowledgment status of a certain type of frame transmission initiated by the STA. In one example, the AP may respond with an ACK to the STA and increment its counter by 1 only if it correctly receives the certain type of frame transmission with an identifier the same as the first identifier at local. In another example, the STA may increment the counter kept at local by 1 only if the STA correctly receives an ACK from the AP for the certain type of frame transmission and at least one of the following conditions is met: (a) there is no pending frame for retransmission; (b) the time interval between two changes of counter at local is larger than a threshold; or (c) the frame transmission is a transmission of a request frame such as such a probe request, an authentication request, an association request, or a reassociation request, etc. In another example, if either the AP or the STA changes its counter, it shall update the identifiers at local accordingly.

In this way, the identifier (e.g., RMA or device ID) of the STA can be randomized and changed according to certain frame transmission status, thus the terminal device can be prevented from being tracked. Furthermore, the identifier of the STA at the AP and at the STA can be implicitly and synchronously changed locally depending on transmission acknowledgment mechanism, which means less signaling overhead and specification effort. Meanwhile, to synchronize the change of identifier for frame transmission and reception, only two identifiers are needed to be kept at the STA and AP, respectively. Therefore, compared with conventional solutions, less implementation complexity and storage can be achieved.

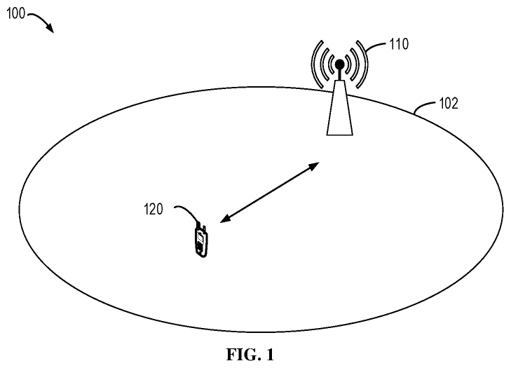

FIG. 1 illustrates an example communication system 100 in which some embodiments of the present disclosure can be implemented. The communication system 100, which is a part of a communication network, includes a first device 120 and a second device 110. For example, the second device 110 may be an access point (e.g., a WiFi device) in an ESS network, and the first device 120 may be an STA in the ESS network. Though only one second device 120 and one second device 110 are shown in FIG. 1, the number of first device 120 and second device 110 is not limited. In other words, there may be one or more first devices 120 and one or more second devices 110 in the network.

The second device 110 can provide services to the first device 120, and the second device 110 and the first device 120 may communicate data and control information with each other. In some embodiments, the second device 110 and the first device 120 may communicate with direct links/channels.

In the system 100, a link from the second device 110 to the first device 120 is referred to as a downlink (DL), while a link from the first device 120 to the second device 110 is referred to as an uplink (UL). In downlink, the second device 110 is a transmitting (TX) device (or a transmitter) and the first device 120 is a receiving (RX) device (or a receiver). In uplink, the first device 120 is a transmitting (TX) device (or a transmitter) and the second device 110 is a RX device (or a receiver). It is to be understood that the second device 110 may provide one or more serving cells. As illustrated in FIG. 1, the second device 110 provides one serving cell 102, and the first device 120 camps on the serving cell 102. In some embodiments, the second device 110 can provide multiple serving cells. It is to be understood that the number of serving cell(s) shown in FIG. 1 is for illustrative purposes only without suggesting any limitation.

The communications in the communication system 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM), Wireless Fidelity (WiFi) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, the sixth generation (6G), or IEEE 802.11 communication protocols.

It is to be understood that the number of devices and their connection relationships and types shown in FIG. 1 are for illustrative purposes only without suggesting any limitation. The communication system 100 may comprise any suitable number of devices adapted for implementing embodiments of the present disclosure.

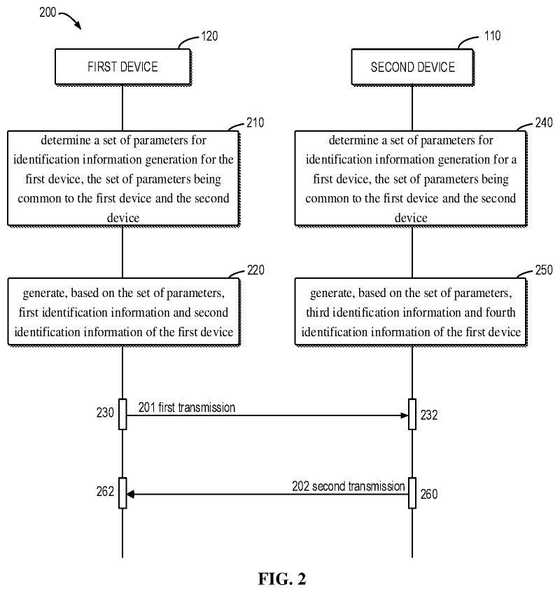

FIG. 2 illustrates a signaling chart illustrating a communication process 200 in accordance with some example embodiments of the present disclosure. Only for the purpose of discussion, the communication process 200 will be described with reference to FIG. 1. The communication process 200 may involve the first device 120 and the second device 110.

In some example embodiments, the first device 120 determines (210) a set of parameters for identification information generation for the first device 120. The set of parameters are common to the first device 120 and the second device 110. At the same time, on the other side of communication, the second device 110 also determines (240) the set of parameters for identification information generation for the first device 120. From the viewpoint of the first device 120, the set of parameters may be determined by the first device 120 through a negotiation with the second device 110 during an association of the first device 120 to the second device 110. From the viewpoint of the second device 110, the set of parameters may be determined by the second device 110 through a negotiation with the first device 120 during an association of the first device 120 to the second device 110. The negotiation may be initiated by the first device 120 or the second device 110. In one example, the set of parameters may comprise at least one of: a rule for generating the first identification information and the second identification information, or a counter for providing a count as an input parameter of the rule. Additionally, the set of parameters further comprises at least one of: a secret key used as an input parameter of the rule and for differentiating the first device 120 from a third device associated with the second device 110, an identification information pool from which the first identification information and the second identification information are generated based on the rule, or an activation/deactivation indication for activating or deactivating the solution provided in this disclosure. Specifically, the activation/deactivation indication for activating or deactivating may indicate activation or deactivation of the first identification information and the second identification information. The rule may be a random function and the counter may be a random seed of the random function. In addition, the first device 120 may transmit, to the second device 110, the count of the local counter (the counter at the first device 120) encrypted with the secret key. Alternatively, the second device 110 may transmit, to the first device 120, the count of the local counter (the counter at the second device 110) encrypted with the secret key.

Additionally, in some example embodiments, the first device 120 generates (220), based on the set of parameters, first identification information and second identification information of the first device 120. On the other side of communication, the second device 110 generates (250), based on the set of parameters, third identification information and fourth identification information of the first device 120. For example, the first identification information, second identification information, third identification information and fourth identification information may each be or include at least one of: an identifier of the first device 120, or a random media access control (MAC) address of the first device 120.

At the first device 120, in generating (220) the first identification information and the second identification information, the first device 120 may generate the first identification information based on the rule and the count provided by the local counter, and generate the second identification information based on the rule and the count plus a number. The number may be predefined or is configured during a negotiation with the second device 110 for the set of parameters. For example, in order to generate the first identification information and the second identification information, the first device 120 may employ the rule with input parameters being at least one of: the secret key, the count of the counter, or the identification information pool.

At the second device 110, in generating (250) the third identification information and the fourth identification information, the second device 110 may generate the third identification information based on the rule and the count provided by the local counter, and generate the fourth identification information based on the rule and the count minus the number which is the same as the number used by the first device 120 to generate the second identification information. For example, in order to generate the third identification information and the fourth identification information, the second device 110 may adopt the same way as the first device 120 generates the first identification information and the second identification information. In other words, in order to generate the third identification information and the fourth identification information, the second device 110 may employ the rule with input parameters being at least one of: the secret key, the count of the counter, or the identification information pool.

Continuing with reference to FIG. 2, the first device 120 further transmits (230), to the second device 110, a first transmission 201. The first transmission 201 comprises the first identification information generated by the first device 120. On the other side of communication, the second device 110 detects (232) the first transmission 201 from the first device 120 using the third identification information and the fourth identification information. For example, the first transmission 201 may be of a predefined or pre-configured type. The predefined type can be defined in specification(s) in advance. The pre-configured type can be determined during the negotiation between the first device 120 and the second device 110. The predefined or pre-configured type may comprise at least one of: a unicast frame transmission, a frame transmission in a pre-association phase related to the first device 120 and the second device 110, a frame transmission during an association of the first device 120 to the second device 110, a management frame transmission, a control frame transmission, or a data frame transmission.

For example, at the second device 110, in detecting the first transmission 201, the second device 110 may compare the first identification information of the first device 120 in the first transmission 201 with the third identification information and the fourth identification information, and based on determining that the first identification information matches the third identification information or the fourth identification information, determine that the first transmission 201 is a valid transmission from the first device 120. In this case, based on determining that the first transmission 201 is a valid transmission from the first device 120, the second device 110 may further transmit an ACK for the first transmission 201 to the first device 120. Specifically, in one example, based on determining that the first identification information matches the third identification information, the second device 110 may update the set of parameters by updating at least one parameter among the set of parameters, and update the third identification information and the fourth identification information based on the updated set of parameters. In updating the at least one parameter among the set of parameters, the second device 110 may update the at least one parameter based on receiving the first transmission 201. Additionally or alternatively, in updating the at least one parameter among the set of parameters, the second device 110 may increment the count of the local counter. In another example, based on determining that the first identification information matches the fourth identification information, the second device 110 may maintain the third identification information and the fourth identification information unchanged.

On the other side of communication, at the first device 120, the second device 120 may receive, from the second device 110, the ACK for the first transmission 201. Upon receipt of the ACK for the first transmission 201, the first device 120 may update the set of parameters by updating at least one parameter among the set of parameters, and update the first identification information and the second identification information based on the updated set of parameters. In updating the at least one parameter among the set of parameters, the first device 120 may update the at least one parameter based on receiving the ACK for the first transmission 201. In addition or alternatively, in updating the at least one parameter among the set of parameters, the first device 120 may increment the count of the local counter. In some examples, updating of the at least one parameter may be further based on at least one of: there is no pending retransmission at the first device 120, time elapsed since the counter at the first device 120 is initialized or incremented for the last time is longer than a threshold, or the first transmission 201 is at least one of: a probe request, an authentication request, an association request, or a reassociation request. The threshold may be negotiated during initialization or determined by the first device 120.

Sometimes receipt of the ACK for the first transmission 201 may fail due to strong interference. In such cases, based on determining that the ACK for the first transmission 201 is not received from the second device 110, the first device 120 may transmit a retransmission of the first transmission 201 to the second device 110. The retransmission comprises the first identification information which is unchanged from the prior first transmission 201.

Continuing with reference to FIG. 2, the second device 110 transmits (260), to the first device 120 a second transmission 202. The second transmission 202 comprises the third identification information. The second transmission 202 may be also of the predefined or pre-configured type. On the other side of communication, the first device 120 detects (262) the second transmission 202 from the second device 110 using the first identification information and the second identification information.

At the first device 120, in detecting the second transmission 202, the first device 120 may compare the third identification information of the first device 120 in the second transmission 202 with the first identification information and the second identification information. Based on determining that the third identification information matches the first identification information or the second identification information, the first device 120 may determine that the second transmission 202 is a valid transmission for the first device 120. Based on determining that the second transmission 202 is a valid transmission for the first device 120, the first device 120 may transmit an ACK for the second transmission 202 to the second device 110. In one example, after receiving the second transmission 202 from the second device 110, the first device 120 may maintain the first identification information and the second identification information unchanged. In another example, after receiving the second transmission 202 from the second device 110, the first device 120 may update the set of parameters by updating at least one parameter among the set of parameters, and update the first identification information and the second identification information based on the updated set of parameters.

Also at the first device 120, the count of the local counter is a first count of a first counter at the first device 120, and the first device 120 may receive, in the second transmission 202, a second count of a second counter at the second device 110, and synchronize the first count of the first counter to the received second count of the second counter. In other words, the first device 120 may set the first count of the first counter to be the received second count of the second counter.

On the other side of communication, at the second device 110, the second device 110 may determine whether the ACK for the second transmission 202 is received. Receipt of the ACK for the second transmission 202 may fail due to strong interference. In such cases, based on determining that the ACK for the second transmission 202 is not received from the first device 120, the second device 110 may transmit a retransmission of the second transmission 202 to the first device 120. The retransmission comprises the third identification information which is unchanged from the prior second transmission 202.

In some example embodiments, the first device 120 may be a non-access point station and the second device 110 may be an access point in an ESS. Alternatively, the first device 120 may be an access point and the second device 110 may be a non-access point station in an ESS. In case that the first device 120 is the access point, based on determining that the count of the local counter is updated, the first device 120 may transmit the updated count to another access point in the ESS. In case the second device 110 is the access point, based on determining that the count of the local counter is updated, the second device 110 may transmit the updated count to another access point in the ESS.

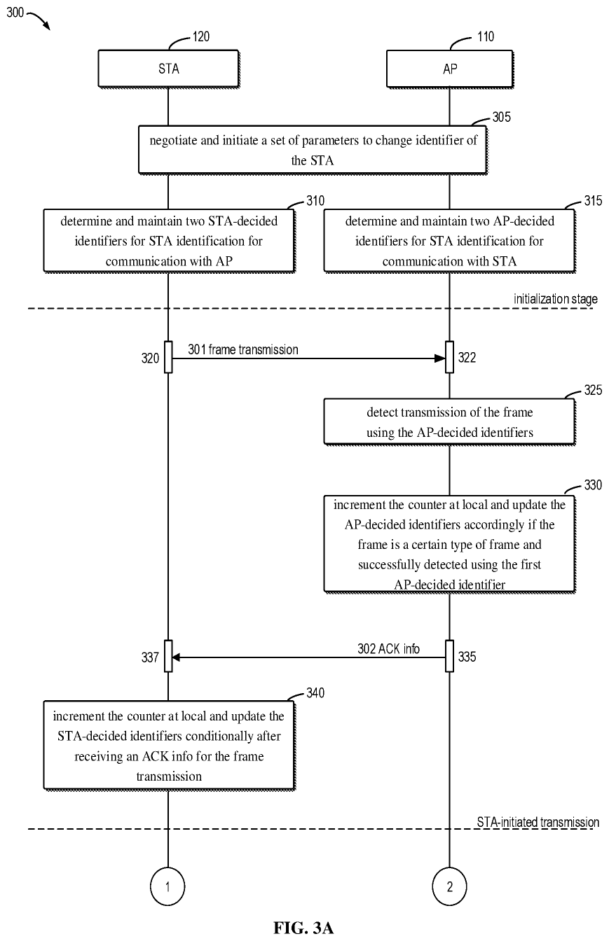

FIG. 3A illustrates another signaling chart illustrating another communication process 300 in accordance with some example embodiments of the present disclosure. Only for the purpose of discussion, the communication process 300 will be described with reference to FIGS. 1 and 2. The communication process 300 may involve an STA 120 and an AP 110. The “STA 120” may also be referred as “first device 120” or “terminal device 120” or “non-access point 120” or simply “non-AP 120”, and “AP 110” may also be referred to as “second device 120” or “network device 110”.

As illustrated in FIG. 3A, the initialization stage involves operations shown with reference to blocks 305, 310 and 315.

At block 305, the STA 120 and the AP 110 negotiate and initiate (determine) a set of parameters (e.g., a share rule, a secret key and a counter) to change identifier of the STA 120. For example, the “identifier” may comprise at least one of: an identifier of the STA 120, or a random MAC address of the STA 120.

In some example embodiments, the negotiation can be initiated by either the terminal device 120 or the network device 110 during association e.g., through a management frame, a control frame or a special action frame. For example, the set of parameters can include but not limited to at least one of the follows:
A shared rule: the shared rule can be pre-defined during specification or be configured during negotiation, which is used to generate identifier for the STA 120.
A secret key: the secret key can be an input parameter of the shared rule to generate identifier, which is used to differentiate different STAs 120.
A counter: the counter can be an input parameter of the shared rule to generate identifier, which is used as a random seed for identifier generation.
An identifier resource pool: the identifier resource pool can include one or more identifiers. If configured, the AP 110 and the STA 120 may generate identifier from the identifier resource pool at least based on the shared rule.
An activation/deactivation indication: the indication can be used to activate or deactivate the proposed solution for change of identifier for the STA 120 for transmission and reception between the STA 120 and the AP 110.

At block 310, the STA 120 determines two identifiers for itself to be identified for communication with the AP 110, and maintains the two identifiers at local, i.e., at the STA 120. The two identifiers determined and maintained by the STA 120 may be referred to as “the first identifier” and “the second identifier” hereafter.

In some example embodiments, the STA 120 and the AP 110 can generate an identifier based on the shared rule taking at least one of the secret key, the counter, the identifier resource pool as the input parameters of the shared rule as below:
Identifier=Rule (the secret key, the counter, the identifier resource pool, other parameters) (1)

The STA 120 may determine and maintain at least two identifiers (i.e., the first identifier and the second identifier, also called as STA-decided identifiers) at least based on the set of configured parameters. In one example, the STA 120 may determine the first identifier based on the shared rule taking the counter at local as an input parameter of the shared rule. In another example, the STA 120 may determine the second identifier based on the shared rule taking the counter at local plus a given number (e.g., 1) as an input parameter of the shared rule. Herein, the given number may be an integer and can be pre-defined or configured during negotiation with the AP 110 in the set of parameters.

At block 315, the AP 110 determines two identifiers for the STA 120 to be identified for communication with the STA 120, and maintains the two identifiers at local, i.e., at the AP 110. The two identifiers determined and maintained by the AP 110 may be referred to as “the third identifier” and “the fourth identifier” hereafter.

In some example embodiments, the AP 110 would also determine and maintain at least two identifiers (i.e., the third identifier and the fourth identifier, also called as AP-decided identifiers) at least based on the set of configured parameters. In one example, the AP 110 may determine the third identifier based on the shared rule taking the counter at local as an input parameter of the shared rule. In another example, the AP 110 may determine the third identifier based on the shared rule taking the counter at local minus the given number (e.g., 1) as an input parameter of the shared rule. For example, the above equation (1) can also be used by the AP 110 to generate the third identifier and the fourth identifier.

Continuing with reference to FIG. 3A, the transmission initiated by the STA 120 (i.e., frame transmission 301) involves operations shown with reference to blocks 320, 322, 325, 330, 335, 337 and 340.

The STA 120 transmits (320) a frame transmission 301, which is initiated by the STA 120 and corresponds to the first transmission 201 in FIG. 2, to the AP 110, using one of the identifiers determined by the STA 120. On the other side of communication, the AP 110 receives (322) the frame transmission 301. Additionally, the STA 120 may transmit the count of the local counter (i.e., the counter at the STA 120) encrypted with the secret key to the AP 110. Upon receiving the count of the counter, the AP 110 may synchronize its local counter with the received counter, and update the third identifier and the fourth identifier based on the synchronized local counter. Alternatively, the AP 110 may transmit the count of the local counter (i.e., the counter at the AP 110) encrypted with the secret key to the STA 120. Upon receiving the count of the counter, the STA 120 may synchronize its local counter with the received counter, and update the first identifier and the second identifier based on the synchronized local counter.

In some example embodiments, the STA 120 may transmit a frame transmission 301 to the AP 110 and indicate the first identifier or the second identifier in the frame transmission 301. In one example, the STA 120 may always use the first identifier for the frame transmission 301, regardless of whether the frame transmission 301 is a first/new transmission or not. In another example, in the case that the frame transmission 301 is a retransmission, the STA 120 may not change the identifier in the frame transmission 301 during retransmission; otherwise, the STA 120 may indicate the first identifier in the frame transmission 301.

In some example embodiments, the frame transmission 301 may be limited to unicast frame transmission, for which there is always a corresponding acknowledgement.

At block 325, the AP 110 detects the frame transmission 301 using the identifiers decided by the AP 110, i.e., the third identifier and the fourth identifier.

In some example embodiments, the AP 110 may detect the frame transmission 301 using the third identifier and the fourth identifier related to the STA 120. For example, the AP 110 may compare the identifier (in this case, the first identifier) received in the frame transmission 301 with the third identifier and the fourth identifier, to identify the STA 120. If the identifier equals either of the third identifier or the fourth identifier, the AP 110 may determine that the frame transmission 301 is a valid frame from the STA 120. Additionally, based on determining that the first transmission 201 is a valid transmission from the first device 120, the AP 110 may transmit (335) ACK information (for example, an ACK) 302 corresponding to the first transmission 301 to the first device 120, this will be described later.

At block 330, if the frame transmission 301 is a certain type of frame and successfully detected using the identifiers determined by the AP 110 (i.e., the third identifier and the fourth identifier), the AP 110 increments the counter at local and updates the identifiers determined by the AP 110 accordingly. In other words, after the AP 110 increments the counter at local, the AP 110 further updates the third identifier and the fourth identifier based on the incremented counter at local.

In some example embodiments, if the frame transmission 301 is a certain type of frame and has been successfully detected using the third identifier, the AP 110 may increment its counter at local by the given number (e.g., 1) and update the third identifier and the fourth identifier.

In one example, the certain type of frame transmission can be limited to any combination of the followings:
unicast frame transmission
frame transmission in pre-association
frame transmission during association
one or more types of management frame transmission

one or more types of control frame transmission, or

data frame transmission

In another example, the certain type of frame transmission may be limited to unicast frame transmission. In another example, the certain type of frame transmission may be limited to pre-association phase used for certain management frames such as probe request/response. In a further example, the certain type of frame transmission may be limited to during association phase for data or/and management frame transmission.

Then, after successfully detecting the frame transmission 301, the AP 110 transmits (335), to the STA 120, ACK information 302 corresponding to the frame transmission 301. The ACK information 302 acknowledges successful receipt of the frame transmission 301 by the AP 110. On the other side of communication, the STA 120 receives (337) the ACK information 302. Upon receipt of the ACK information 302, at block 340, the STA 120 increments the counter at local (i.e., at the STA 120) and then updates the identifiers decided by the STA 120 (i.e., the first identifier and the second identifier) conditionally.

In some example embodiments, if the AP 110 successfully detects the frame transmission 301, it may transmit ACK information 302 to the STA 120 as a response to the frame transmission 301. Upon successfully receiving the ACK information 302 associated with the frame transmission 301, the STA 120 may increment the counter at local by a given number (e.g., 1) conditionally to synchronize the change of identifier with the AP 110. For example, the conditions to trigger the change of counter may be at least one of the following: (a) there is no pending frame for retransmission, (b) the time interval between two changes of counter at local is larger than a threshold, or (c) the frame transmission 301 is at least one of: a probe request, an authentication request, an association request, or a reassociation request. For example, the threshold mentioned above may be negotiated during initialization or be determined by the STA 120 on demand. If the STA 120 changes its counter at local, it may update the first identifier and the second identifier based on the changed counter at local.

FIG. 3B illustrates another signaling chart illustrating another communication process 380 in accordance with some example embodiments of the present disclosure. FIG. 3B is a continuation of FIG. 3A. Only for the purpose of discussion, the communication process 380 will be described with reference to FIGS. 1, 2 and 3A. Like the communication process 300, the communication process 380 may also involve the STA 120 and the AP 110 described with reference to FIG. 3A.

As illustrated in FIG. 3B, the transmission initiated by the AP 110 (i.e., frame transmission 303) involves operations shown with reference to blocks 355, 357, 360, 365 and 367. It is to be noted that the transmission initiated by the AP 110 (i.e., frame transmission 303) does not necessarily happen after the transmission initiated by the STA 120 (i.e., frame transmission 301), nor is dependent on the transmission initiated by the STA 120. The order of the two transmissions (i.e., frame transmission 301 and frame transmission 303) is irrelevant, and the order of the two transmissions shown in FIGS. 3A and 3B is only for illustrative purpose and should not be deemed as limiting. In other words, after the initialization stage is finished, the transmission initiated by the AP 110 may also happen before the transmission initiated by the STA 120, or the two transmissions may overlap with each other in time domain.

The AP 110 transmits (355) a frame transmission 303, which is initiated by the AP 110 and corresponds to the second transmission 202 in FIG. 2, to the STA 120, using one of the identifiers determined by the AP 110. The second transmission 303 may comprise a count of the counter of the AP 110. On the other side of communication, the STA 120 receives (357) the frame transmission 303.

In some example embodiments, the AP 110 may initiate unicast frame transmission to the STA 120 and indicate the third identifier or the fourth identifier in the frame transmission 303, just like the frame transmission 301 at the STA 120.

At block 360, the STA 120 detects the frame transmission 303 using the third identifier and the fourth identifier.

In some example embodiments, the STA 120 may detect the frame transmission 303 using the first identifier and the second identifier, just like the detection of the frame transmission 301 at the AP 110, as illustrated in block 325 in FIG. 3A. Upon successful receipt of the frame transmission 303, the STA 120 synchronizes its count of the local counter to the received count of the counter of the AP 110. Additionally, the STA 120 transmits ACK information (for example, an ACK) 304 corresponding to the frame transmission 303 to the AP 110. For example, if the STA 120 successfully detects the frame transmission 303, it may transmit the ACK information 304 to the AP 110 as a response to the frame transmission 303.

In some example embodiments related to multiple APs 110 in the same ESS, the AP 110 may, upon updating the count of the counter at local, transmit the updated count to another AP in the ESS. For example, if the STA 120 has some identifiable frame exchange with an AP 110, the AP 110 may synchronize the counter related to the STA 120 with other APs 110 in the same ESS. For example, after the AP 110 updates the counter at local, it may tell the counter value to other APs 110 in the whole ESS, even though the other APs 110 may not be in communication with the STA 120.

For the given embodiments above, the frame transmission 303 initiated by the AP 110 will not trigger the change of the identifier at the AP 110 and the STA 120.

In some example embodiments, the solution described herein can be extended to change the identifier related to the STA 120 depending on the frame transmission 303 initiated by the AP 110, by reusing the same mechanism as the frame transmission 301 initiated by the STA 120. Alternatively, for example, the solution described herein can also be extended to change identifier of the STA 120 by exchanging the role between the AP 110 and the STA 120.

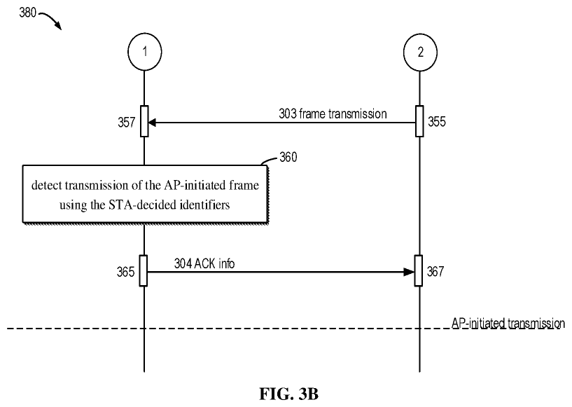

FIG. 4 illustrates an example process 400 of frame transmission in accordance with some example embodiments of the present disclosure. The example process 400 may involve the STA 120 and the AP 110. In this example process 400, the STA 120 plays the role of the first device (or non-AP station) as illustrated in FIGS. 1-3, and the AP 120 plays the role of the second device (or access point) as illustrated in FIGS. 1-3. It is to be noted that the roles of the STA 120 and the AP 110 may also be exchanged. In the example illustrated in FIG. 4, it is assumed that all the frames are certain type of frames as defined or configured before. For example, the certain type of frames may be predefined in specification(s) or may be pre-configured during the negotiation between the STA 120 and AP 110 at a pre-association phase. Specifically, the AP 110 may synchronize change of STA's RMA (which corresponds to the first identification information and the second identification information of the second device 120 as described before) with the STA 120 based on acknowledgment of frame transmission. Only for the purpose of discussion, the example process 400 will be described with reference to FIGS. 1-3.

As illustrated in FIG. 4, during initialization stage, both STA 120 (for example, the terminal device 120 as illustrated in FIGS. 1-2 and the STA 120 as illustrated in FIGS. 3A and 3B) and AP 110 (for example, the network device 110 as illustrated in FIGS. 1-2 and the AP 110 as illustrated in FIGS. 3A and 3B) will negotiate and configure at least a shared rule, a secret key, and a counter (with value n). The STA 120 may generate two RMAs (which corresponds to the first identification information and the second identification information of the first device 120 as described before) at least based on the counter n at local (which corresponds to the counter at the first device 120 as described before), i.e., a first RMA, which is also referred to as RMA(n) (which corresponds to the first identification information of the first device), and a second RMA, i.e., RMA(n+1) (which corresponds to the second identification information of the first device). Similarly, the AP 110 may generate two RMAs (which corresponds to the third identification information and the fourth identification information of the first device 120 as described before) at least based on the counter n at local (which corresponds to the counter at the second device 110 as described before), i.e., a first AP-decided RMA, which is also referred to as RMA(n) (which corresponds to the third identification information as described before), and a second RMA, i.e., RMA(n−1) (which corresponds to the fourth identification information as described before).

As illustrated in FIG. 4, transmission of frame 1 is initiated by the STA 120. The STA 120 carries the RMA(n) (i.e., the first RMA) in the frame 1, and the AP 110 would detect the transmission of the frame 1 using RMA(n−1) and RMA(n). If the AP 110 detects that the frame 1 is certain type of frame (e.g., unicast frame) and that the RMA carried in the frame 1 equals the first RMA at local, the AP 110 will increment the local counter to (n+1) and send an ACK to the STA 120. After change of counter at local, the AP 110 will update its RMAs at local to RMA(n) and RMA(n+1). On the other side of communication, upon receiving the ACK for transmission of frame 1, the STA 120 will also increment the counter at local to (n+1). After change of counter at local, the STA 120 will update its RMAs at local to RMA(n+1) and RMA(n+2).

Transmission of the subsequent frame, i.e., frame 2, is also initiated by the STA 120. The STA 120 carries the RMA(n+1) (i.e., the first RMA) in the frame 2, and the AP 110 may detect the transmission of the frame 2 using RMA(n) and RMA(n+1). If the frame transmission fails e.g., due to strong interference, the STA 120 cannot receive an ACK for the transmission of frame 2. Then the STA 120 would retransmit the frame 2 without change of RMA in the frame 2. The AP 110 will still use RMA(n) and RMA(n+1) to detect the transmission of frame 2. If the AP 110 detects that the frame 2 is certain type of frame (e.g., unicast frame) and the RMA carried in the frame 2 equals the first RMA at local, it will increment the counter to (n+2) and send an ACK to the STA 120. After change of counter at local, the AP 110 will update its RMAs at local to RMA(n+1) and RMA(n+2). On the other side of communication, upon receiving the ACK for retransmission of frame 2, the STA 120 will increment the counter at local to (n+2). After change of counter at local, the STA 120 will update its RMAs at local to RMA(n+2) and RMA(n+3).

Transmission of the subsequent frame, i.e., frame 3, is also initiated by the STA 120. The STA 120 carries the RMA(n+2) (i.e., the first RMA) in the frame, and the AP 110 would detect the transmission of frame 3 using RMA(n+1) and RMA(n+2). If the transmission of frame 3 succeeds and the RMA carried in the frame 3 equals the first RMA at local, i.e., RMA(n+2), the AP would increment the counter to (n+3) and send an ACK to the STA 120. Alternatively, based on determining that the first identification information matches the fourth identification information, the AP 110 may maintain the third identification information and the fourth identification information unchanged. After change of counter at local, the AP 110 will update its RMAs at local to RMA(n+2) and RMA(n+3). However, the STA 120 can't successfully decode the ACK for the frame 3 due to strong interference, so it would retransmit the frame 3 without change of RMA in the frame 3.

The AP 110 will use RMA(n+2) and RMA(n+3) to detect the transmission of frame 3. Even if the reception of frame 3 succeeds, the AP 110 wouldn't increment the counter as the RMA carried in the frame 3 doesn't equal the first RMA at local, i.e., RMA(n+3), and then it would send an ACK to the STA for retransmission of the frame 3. On the other side of communication, upon receiving the ACK for retransmission of frame 3, the STA 120 will increment the counter at local to (n+3). After change of counter at local, the STA 120 will update its RMAs at local to RMA(n+3) and RMA(n+4).

Transmission of the subsequent frame, i.e., frame 4, is initiated by the AP 110. The AP 110 carries the RMA(n+3) (i.e., the first RMA) in the frame 4, and the STA 120 would detect the transmission of frame 4 using RMA(n+3) and RMA(n+4) at local. In the transmission of frame 4, the count of the local of the AP 110 may also be comprised. If the transmission of frame 4 fails due to strong interference, the AP 110 wouldn't receive an ACK for the transmission of frame 4.

The AP 110 would retransmit the frame 4 without change of RMA in the frame 4. The STA 120 will still use RMA(n+3) and RMA(n+4) to detect the transmission of frame 4. If the transmission of frame 4 succeeds, the STA 120 would synchronize its local count of its local counter to the received count of the counter of the AP 110, and send an ACK to the AP 110. However, the AP 110 can't successfully decode the ACK for the frame 4 due to strong interference, and it would retransmit the frame 4 without change of RMA in the frame 4. On the other side of communication, the STA 120 will use RMA(n+3) and RMA(n+4) to detect the transmission of frame 4 again. If the reception of frame 4 succeeds, the STA 120 would send an ACK to the AP 110.

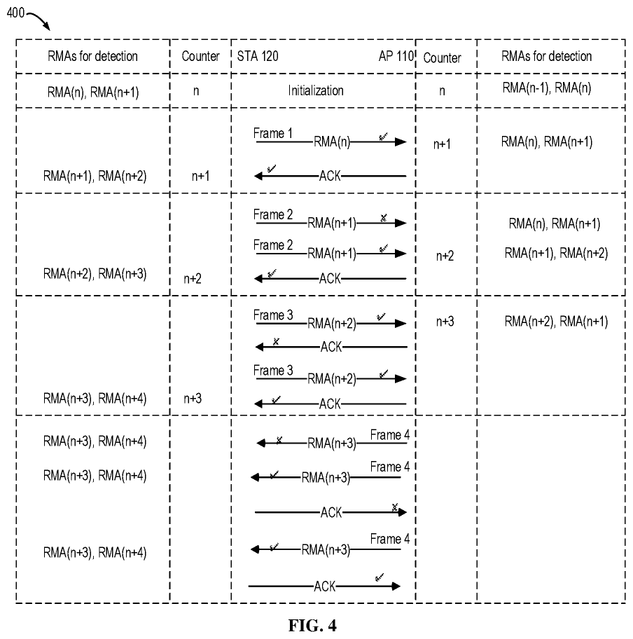

FIG. 5 illustrates a flowchart of an example method 500 implemented at a first device 120 in accordance with some other embodiments of the present disclosure. For the purpose of discussion, the method 500 will be described from the perspective of the first device 120 (i.e., STA 120) with reference to FIGS. 1-4.

At block 510, the first device 120 (e.g., the STA 120 shown in FIGS. 3-4) determines a set of parameters for identification information generation for the first device 120. The set of parameters is common to the first device 120 and the second device 110. At block 520, the first device 120 generates, based on the set of parameters, first identification information and second identification information of the first device 120. At block 530, the first device 120 transmits, to the second device 110, a first transmission (e.g., the first transmission 201 as illustrated in FIG. 2 or the frame transmission 301 as illustrated in FIG. 3A) comprising the first identification information. At block 540, the first device 120 detects a second transmission (e.g., the second transmission 202 as illustrated in FIG. 2 or the frame transmission 303 as illustrated in FIG. 3B) from the second device 110 using the first identification information and the second identification information.

In some example embodiments, the set of parameters is determined through a negotiation with the second device 120 during an association of the first device 110 to the second device 120. The negotiation may be initiated by the first device 120 or the second device 110.

In some example embodiments, the first transmission and the second transmission are of a predefined or pre-configured type.

In some example embodiments, the predefined type can be defined in specification(s), and the pre-configured type can be determined during the negotiation between the first device 120 and the second device 110. The predefined or pre-configured type comprises at least one of: a unicast frame transmission, a frame transmission in a pre-association phase related to the first device 120 and the second device 110, a frame transmission during an association of the first device 120 to the second device 110, a management frame transmission, a control frame transmission, or a data frame transmission.

In some example embodiments, the method 500 further comprises: receiving, from the second device 110, an ACK for the first transmission; updating the set of parameters by updating at least one parameter among the set of parameters; and updating the first identification information and the second identification information based on the updated set of parameters.

In some example embodiments, the first device 120 detects the second transmission by: comparing third identification information of the first device 120 in the second transmission with the first identification information and the second identification information; and based on determining that the third identification information matches the first identification information or the second identification information, determining that the second transmission is a valid transmission for the first device 120.

In some example embodiments, the method 500 further comprises: based on determining that the second transmission is a valid transmission for the first device 120, transmitting an ACK (e.g., the ACK info 304 as illustrated in FIG. 3B) for the second transmission to the second device 110.

In some example embodiments, the set of parameters comprises at least one of: a rule for generating the first identification information and the second identification information; or a counter for providing a count as an input parameter of the rule.

In some example embodiments, the set of parameters further comprises at least one of: a secret key used as an input parameter of the rule and for differentiating the first device 120 from a third device associated with the second device 110, an identification information pool from which the first identification information and the second identification information are generated based on the rule, or an activation/deactivation indication for activating or deactivating the first identification information and the second identification information.

In some example embodiments, the method 500 further comprises: transmitting, to the second device 110, the count of the counter encrypted with the secret key.

In some example embodiments, the first device 120 generates the first identification information and the second identification information by: generating the first identification information based on the rule and the count provided by the counter; and generating the second identification information based on the rule and the count plus a number.

In some example embodiments, the number is predefined or is configured during a negotiation with the second device 110 for the set of parameters.

In some example embodiments, the first device 120 generates the first identification information and the second identification information by: employing the rule with input parameters being at least one of the secret key, the count of the counter, or the identification information pool.

In some example embodiments, the rule is a random function and the counter is a random seed of the random function.

In some example embodiments, the first device 120 updates the at least one parameter among the set of parameters by: updating the at least one parameter based on receiving the ACK for the first transmission.

In some example embodiments, updating of the at least one parameter is further based on at least one of: there is no pending retransmission at the first device 120, time elapsed since the counter is initialized or incremented is longer than a threshold, or the first transmission is at least one of: a probe request, an authentication request, an association request, or a reassociation request.

In some example embodiments, the threshold is negotiated during initialization or determined by the first device 120.

In some example embodiments, the first device 120 updates the at least one parameter among the set of parameters by: incrementing the count of the counter.

In some example embodiments, the method 500 further comprises: after receiving the second transmission from the second device 110, maintaining the first identification information and the second identification information unchanged.

In some example embodiments, the method 500 further comprises: after receiving the second transmission from the second device 110, updating the set of parameters by updating at least one parameter among the set of parameters; and updating the first identification information and the second identification information based on the updated set of parameters.

In some example embodiments, the count of the counter is a first count of a first counter at the first device 120, and the method 500 further comprises: receiving, in the second transmission, a second count of a second counter at the second device 110; and synchronizing the first count of the first counter to the received second count of the second counter.

In some example embodiments, the method 500 further comprises: based on determining that an ACK for the first transmission is not received from the second device 110, transmitting a retransmission of the first transmission to the second device 110. The retransmission comprises the first identification information.

In some example embodiments, the first identification information or the second identification information comprises at least one of: an identifier of the first device 120, or a random media access control (MAC) address of the first device 120.

In some example embodiments, the first device 120 is a non-access point station and the second device 110 is an access point in an ESS, or the first device 120 is an access point and the second device 110 is a non-access point station in an ESS.

In some example embodiments, the first device 120 is the access point, and the method 500 further comprises: based on determining that the count of the counter is updated, transmitting the updated count to another access point in the ESS.

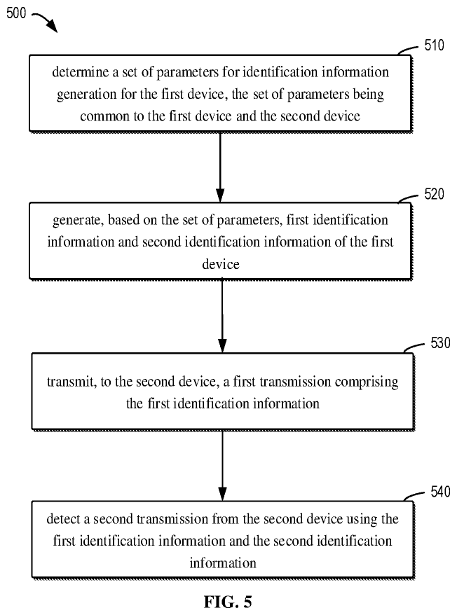

FIG. 6 illustrates another flowchart of an example method 600 implemented at a second device in accordance with some other embodiments of the present disclosure. For the purpose of discussion, the method 600 will be described from the perspective of the second device 110 (i.e., AP 110) with reference to FIGS. 1-4.

At block 610, the second device 110 determines a set of parameters for identification information generation for a first device 120. The set of parameters is common to the first device 120 and the second device 110. At block 620, the second device 110 generates, based on the set of parameters, third identification information and fourth identification information of the first device 120. At block 630, the second device 110 detects a first transmission (e.g., the first transmission 201 as illustrated in FIG. 2 or the frame transmission 301 as illustrated in FIG. 3A) from the first device 120 using the third identification information and the fourth identification information. At block 640, the second device 110 transmits, to the first device 120, a second transmission (e.g., the second transmission 202 as illustrated in FIG. 2 or the frame transmission 303 as illustrated in FIG. 3B) comprising the third identification information.

In some example embodiments, the set of parameters is determined through a negotiation with the first device 120 during an association of the first device 120 to the second device 110. The negotiation may be initiated by the first device 120 or the second device 110.

In some example embodiments, the first transmission and the second transmission are of a predefined or pre-configured type.

In some example embodiments, the predefined type can be defined in specification(s), and the pre-configured type can be determined during the negotiation between the first device 120 and the second device 110. The predefined or pre-configured type comprises at least one of: a unicast frame transmission, a frame transmission in a pre-association phase related to the first device 120 and the second device 110, a frame transmission during an association of the first device 120 to the second device 110, a management frame transmission, a control frame transmission, or a data frame transmission.

In some example embodiments, the second device 110 detects the first transmission by: comparing first identification information of the first device 120 in the first transmission with the third identification information and the fourth identification information; and based on determining that the first identification information matches the third identification information or the fourth identification information, determining that the first transmission is a valid transmission from the first device 120.

In some example embodiments, the method 600 further comprises: based on determining that the first transmission is a valid transmission from the first device 120, transmitting an ACK for the first transmission to the first device 120.

In some example embodiments, the method 600 further comprises: based on determining that the first identification information matches the third identification information, updating the set of parameters by updating at least one parameter among the set of parameters; and updating the third identification information and the fourth identification information based on the updated set of parameters.

In some example embodiments, the method 600 further comprises: based on determining that the first identification information matches the fourth identification information, maintaining the third identification information and the fourth identification information unchanged.

In some example embodiments, the set of parameters comprises at least one of: a rule for generating the third identification information and the fourth identification information; or a counter for providing a count as an input parameter of the rule.

In some example embodiments, the set of parameters further comprises at least one of: a secret key used as an input parameter of the rule and for differentiating the first device 120 from a third device associated with the second device 110, an identification information pool from which the third identification information and the fourth identification information are generated based on the rule, or an activation/deactivation indication for activating or deactivating the third identification information and the fourth identification information.

In some example embodiments, the method 600 further comprises: transmitting, to the first device 120, the count of the counter encrypted with the secret key.

In some example embodiments, the second device 110 generates the third identification information and the fourth identification information by: generating the third identification information based on the rule and the count provided by the counter; and generating the fourth identification information based on the rule and the count minus a number.

In some example embodiments, the number is predefined or is configured during a negotiation with the first device 120 for the set of parameters.

In some example embodiments, the second device 110 generates the third identification information and the fourth identification information by: employing the rule with input parameters being at least one of the secret key, the count of the counter, or the identification information pool.

In some example embodiments, the rule is a random function and the counter is a random seed of the random function.

In some example embodiments, the second device 110 updates the at least one parameter among the set of parameters by: updating the at least one parameter based on receiving the first transmission.

In some example embodiments, the second device 110 updates the at least one parameter among the set of parameters by: incrementing the count of the counter.

In some example embodiments, the method 600 further comprises: based on determining that an ACK for the second transmission (e.g., the ACK info 304 as illustrated in FIG. 3B) is not received from the first device 120, transmitting a retransmission of the second transmission to the first device 120. The retransmission comprises the third identification information.

In some example embodiments, the third identification information or the fourth identification information comprises at least one of: an identifier of the first device 120, or a random media access control (MAC) address of the first device 120.

In some example embodiments, the first device 120 is a non-access point station and the second device 110 is an access point in an ESS, or the first device 120 is an access point and the second device 110 is a non-access point station in an ESS.

In some example embodiments, the second device 110 is the access point and the method 600 further comprises: based on determining that the count of the counter is updated, transmitting the updated count to another access point in the ESS.

In some embodiments, an apparatus capable of performing the method 500 (for example, the first device 120) may comprise means for performing the respective steps of the method 500. The means may be implemented in any suitable form. For example, the means may be implemented in a circuitry or software module.

In some example embodiments, the apparatus comprises: means for determining, at the first device 120, a set of parameters for identification information generation for the first device 120, the set of parameters being common to the first device 120 and the second device 110; means for generating, based on the set of parameters, first identification information and second identification information of the first device 120; means for transmitting, to the second device 110, a first transmission comprising the first identification information; and means for detecting a second transmission from the second device using the first identification information and the second identification information.

In some example embodiments, the set of parameters is determined through a negotiation with the second device 120 during an association of the first device 110 to the second device 120. The negotiation may be initiated by the first device 120 or the second device 110.

In some example embodiments, the first transmission and the second transmission are of a pre-defined or pre-configured type.

In some example embodiments, the predefined type can be defined in specification(s), and the pre-configured type can be determined during the negotiation between the first device 120 and the second device 110. The pre-defined or pre-configured type comprises at least one of: a unicast frame transmission, a frame transmission in a pre-association phase related to the first device 120 and the second device 110, a frame transmission during an association of the first device 120 to the second device 110, a management frame transmission, a control frame transmission, or a data frame transmission.

In some example embodiments, the apparatus further comprises: means for receiving, from the second device 110, an ACK for the first transmission; means for updating the set of parameters comprising means for updating at least one parameter among the set of parameters; and means for updating the first identification information and the second identification information based on the updated set of parameters.

In some example embodiments, the means for detecting a second transmission from the second device using the first identification information and the second identification information comprises: means for comparing third identification information of the first device 120 in the second transmission with the first identification information and the second identification information; and means for based on determining that the third identification information matches the first identification information or the second identification information, determining that the second transmission is a valid transmission for the first device 120.

In some example embodiments, the apparatus further comprises: means for based on determining that the second transmission is a valid transmission for the first device 120, transmitting an ACK (e.g., the ACK info 304 as illustrated in FIG. 3B) for the second transmission to the second device 110.

In some example embodiments, the set of parameters comprises at least one of: a rule for generating the first identification information and the second identification information; or a counter for providing a count as an input parameter of the rule.

In some example embodiments, the set of parameters further comprises at least one of: a secret key used as an input parameter of the rule and for differentiating the first device 120 from a third device associated with the second device 110, an identification information pool from which the first identification information and the second identification information are generated based on the rule, or an activation/deactivation indication for activating or deactivating the first identification information and the second identification information.

In some example embodiments, the apparatus further comprises: means for transmitting, to the second device 110, the count of the counter encrypted with the secret key.

In some example embodiments, the means for generating, based on the set of parameters, first identification information and second identification information of the first device 120 comprises: means for generating the first identification information based on the rule and the count provided by the counter; and means for generating the second identification information based on the rule and the count plus a number.

In some example embodiments, the number is predefined or is configured during a negotiation with the second device 110 for the set of parameters.

In some example embodiments, the means for generating, based on the set of parameters, first identification information and second identification information of the first device 120 comprises: means for employing the rule with input parameters being at least one of the secret key, the count of the counter, or the identification information pool.

In some example embodiments, the rule is a random function and the counter is a random seed of the random function.

In some example embodiments, the means for updating the at least one parameter among the set of parameters comprises: means for updating the at least one parameter based on receiving the ACK for the first transmission.

In some example embodiments, the means for updating the at least one parameter among the set of parameters further comprises: means for updating the at least one parameter based on at least one of: there is no pending retransmission at the first device 120, time elapsed since the counter is initialized or incremented is longer than a threshold, or the first transmission is at least one of: a probe request, an authentication request, an association request, or a reassociation request.

In some example embodiments, the threshold is negotiated during initialization or determined by the first device 120.

In some example embodiments, the means for updating at least one parameter among the set of parameters comprises: means for incrementing the count of the counter.

In some example embodiments, the apparatus further comprises: means for after receiving the second transmission from the second device 110, maintaining the first identification information and the second identification information unchanged.

In some example embodiments, the apparatus further comprises: means for after receiving the second transmission from the second device 110, updating the set of parameters by updating at least one parameter among the set of parameters; and means for updating the first identification information and the second identification information based on the updated set of parameters.

In some example embodiments, the count of the counter is a first count of a first counter at the first device 120, and the apparatus further comprises: means for receiving, in the second transmission, a second count of a second counter at the second device 110; and means for synchronizing the first count of the first counter to the received second count of the second counter.

In some example embodiments, the apparatus further comprises: means for based on determining that an ACK for the first transmission is not received from the second device 110, transmitting a retransmission of the first transmission to the second device 110. The retransmission comprises the first identification information.

In some example embodiments, the first identification information or the second identification information comprises at least one of: an identifier of the first device 120, or a random media access control (MAC) address of the first device 120.

In some example embodiments, the first device 120 is a non-access point station and the second device 110 is an access point in an ESS, or the first device 120 is an access point and the second device 110 is a non-access point station in an ESS.

In some example embodiments, the first device 120 is the access point, and the apparatus further comprises: means for based on determining that the count of the counter is updated, transmitting the updated count to another access point in the ESS.

In some embodiments, the apparatus further comprises means for performing other steps in some embodiments of the method 500. In some embodiments, the means comprises at least one processor and at least one memory including computer program code, the at least one memory and computer program code configured to, with the at least one processor, cause the performance of the apparatus.

In some embodiments, an apparatus capable of performing the method 600 (for example, the second device 110) may comprise means for performing the respective steps of the method 600. The means may be implemented in any suitable form. For example, the means may be implemented in a circuitry or software module.

In some example embodiments, the apparatus comprises: means for determining, at the second device 110, a set of parameters for identification information generation for the first device 120, the set of parameters being common to the first device 120 and the second device 110; means for generating, based on the set of parameters, third identification information and fourth identification information of the first device 120; means for detecting a first transmission from the first device 120 using the third identification information and the fourth identification information; and means for transmitting, to the first device 120, a second transmission comprising the third identification information.

In some example embodiments, the set of parameters is determined through a negotiation with the first device 120 during an association of the first device 120 to the second device 110. The negotiation may be initiated by the first device 120 or the second device 110.

In some example embodiments, the first transmission and the second transmission are of a predefined or pre-configured type.

In some example embodiments, the predefined type can be defined in specification(s), and the pre-configured type can be determined during the negotiation between the first device 120 and the second device 110. The predefined or pre-configured type comprises at least one of: a unicast frame transmission, a frame transmission in a pre-association phase related to the first device 120 and the second device 110, a frame transmission during an association of the first device 120 to the second device 110, a management frame transmission, a control frame transmission, or a data frame transmission.

In some example embodiments, the means for detecting the first transmission from the first device 120 comprises: means for comparing first identification information of the first device 120 in the first transmission with the third identification information and the fourth identification information; and means for based on determining that the first identification information matches the third identification information or the fourth identification information, determining that the first transmission is a valid transmission from the first device 120.

In some example embodiments, the apparatus further comprises: means for based on determining that the first transmission is a valid transmission from the first device 120, transmitting an ACK for the first transmission to the first device 120.

In some example embodiments, the apparatus further comprises: means for based on determining that the first identification information matches the third identification information, updating the set of parameters, the means for updating the set of parameters comprising means for updating at least one parameter among the set of parameters; and means for updating the third identification information and the fourth identification information based on the updated set of parameters.

In some example embodiments, the apparatus further comprises: means for based on determining that the first identification information matches the fourth identification information, maintaining the third identification information and the fourth identification information unchanged.

In some example embodiments, the set of parameters comprises at least one of: a rule for generating the third identification information and the fourth identification information; or a counter for providing a count as an input parameter of the rule.

In some example embodiments, the set of parameters further comprises at least one of: a secret key used as an input parameter of the rule and for differentiating the first device 120 from a third device associated with the second device 110, an identification information pool from which the third identification information and the fourth identification information are generated based on the rule, or an activation/deactivation indication for activating or deactivating the third identification information and the fourth identification information.

In some example embodiments, the apparatus further comprises: means for transmitting, to the first device 120, the count of the counter encrypted with the secret key.

In some example embodiments, the means for generating, based on the set of parameters, third identification information and fourth identification information of the first device 120 comprises: means for generating the third identification information based on the rule and the count provided by the counter; and means for generating the fourth identification information based on the rule and the count minus a number.

In some example embodiments, the number is predefined or is configured during a negotiation with the first device 120 for the set of parameters.

In some example embodiments, the means for generating, based on the set of parameters, third identification information and fourth identification information of the first device 120 comprises: means for employing the rule with input parameters being at least one of the secret key, the count of the counter, or the identification information pool.

In some example embodiments, the rule is a random function and the counter is a random seed of the random function.

In some example embodiments, the means for updating at least one parameter among the set of parameters comprises: means for updating the at least one parameter based on receiving the first transmission.

In some example embodiments, the means for updating at least one parameter among the set of parameters comprises: means for incrementing the count of the counter.

In some example embodiments, the apparatus further comprises: means for based on determining that an ACK for the second transmission (e.g., the ACK info 304 as illustrated in FIG. 3B) is not received from the first device 120, transmitting a retransmission of the second transmission to the first device 120. The retransmission comprises the third identification information.

In some example embodiments, the third identification information or the fourth identification information comprises at least one of: an identifier of the first device 120, or a random media access control (MAC) address of the first device 120.

In some example embodiments, the first device 120 is a non-access point station and the second device 110 is an access point in an ESS, or the first device 120 is an access point and the second device 110 is a non-access point station in an ESS.

In some example embodiments, the second device 110 is the access point and the apparatus further comprises: means for based on determining that the count of the counter is updated, transmitting the updated count to another access point in the ESS.

In some embodiments, the apparatus further comprises means for performing other steps in some embodiments of the method 600. In some embodiments, the means comprises at least one processor and at least one memory including computer program code, the at least one memory and computer program code configured to, with the at least one processor, cause the performance of the apparatus.

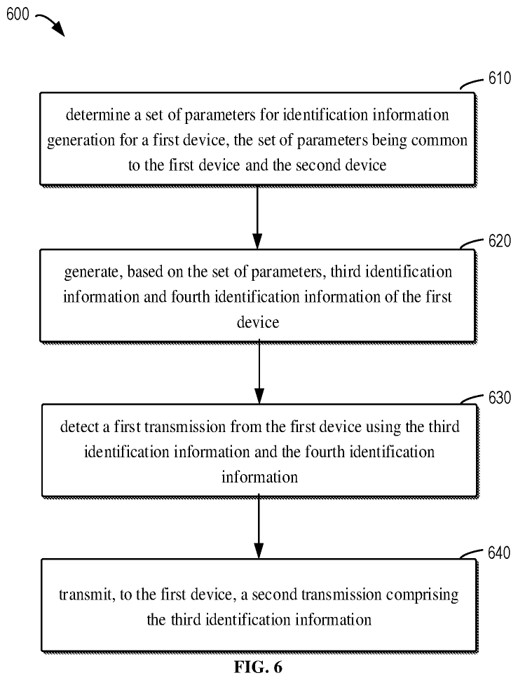

FIG. 7 illustrates a simplified block diagram of a device 700 that is suitable for implementing some example embodiments of the present disclosure. The device 700 may be provided to implement a communication device, for example, the AP device 110 or the STA device 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 2 to 3. The embodiments of the present disclosure may also be implemented by hardware or by a combination of software and hardware.

In some example embodiments, the program 730 may be tangibly contained in a computer-readable medium which may be included in the device 700 (such as in the memory 720) or other storage devices that are accessible by the device 700. The device 700 may load the program 730 from the computer-readable medium to the RAM 722 for execution. The computer-readable medium may include any types of tangible non-volatile storage, such as ROM, EPROM, a flash memory, a hard disk, CD, DVD, and the like.

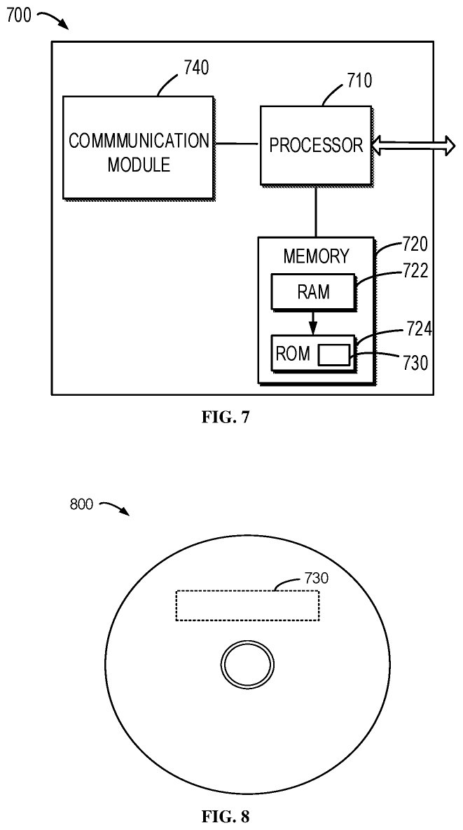

FIG. 8 illustrates a block diagram of an example of a computer-readable medium 1000 in accordance with some example embodiments of the present disclosure. The computer-readable medium 800 has the program 730 stored thereon. It is noted that although the computer-readable medium 800 is depicted in form of CD or DVD in FIG. 10, the computer-readable medium 800 may be in any other form suitable for carry or hold the program 730.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer-readable storage medium. The computer program product includes computer-executable instructions, such as those included in program modules, being executed in a device on a target real or virtual processor, to carry out the method 500 or 600 as described above with reference to FIG. 5 or 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer-readable medium, and the like.

The computer-readable medium may be a computer-readable signal medium or a computer-readable storage medium. A computer-readable medium may include but not limited to an electronic, magnetic, optical, electromagnetic, infrared, or semiconductor system, apparatus, or device, or any suitable combination of the foregoing. More specific examples of the computer-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-51. (canceled)

52. A first device comprising:
at least one processor; and
at least one memory storing instructions that, when executed by the at least one processor, cause the first device to:
determine a set of parameters for identification information generation for the first device, the set of parameters being common to the first device and a second device;
generate, based on the set of parameters, first identification information and second identification information of the first device;
transmit, to the second device, a first transmission comprising the first identification information; and
detect a second transmission from the second device using the first identification information and the second identification information.

53. The first device of claim 52, wherein the set of parameters is determined through a negotiation with the second device during an association of the first device to the second device, the negotiation being initiated by the first device or the second device.

54. The first device of claim 53, wherein the first transmission and the second transmission are of a predefined or pre-configured type.

55. The first device of claim 54, wherein the pre-configured type is determined during the negotiation between the first device and the second device, and the predefined or pre-configured type comprises at least one of the following:
a unicast frame transmission,
a frame transmission in a pre-association phase related to the first device and the second device,
a frame transmission during an association of the first device to the second device,
a management frame transmission,
a control frame transmission, or
a data frame transmission.

56. The first device of claim 52, wherein
the at least one memory storing instructions that, when executed by the at least one processor, further cause the first device to:
receive, from the second device, an acknowledgement (ACK) for the first transmission;
update the set of parameters by updating at least one parameter among the set of parameters; and
update the first identification information and the second identification information based on the updated set of parameters.

57. The first device of claim 52, wherein
the at least one memory storing instructions that, when executed by the at least one processor, further cause the first device to:
compare third identification information of the first device in the second transmission with the first identification information and the second identification information to detect the second transmission; and
based on the comparing that the third identification information matches the first identification information or the second identification information, determine that the second transmission is a valid transmission for the first device.

58. The first device of claim 57, wherein
the at least one memory storing instructions that, when executed by the at least one processor, further cause the first device to:
transmit an acknowledgement (ACK) for the second transmission to the second device based on the comparing that the second transmission is a valid transmission for the first device.

59. The first device of claim 52, wherein the set of parameters comprises at least one of the following:
a rule for generating the first identification information and the second identification information; or
a counter for providing a count as an input parameter of the rule.

60. The first device of claim 59, wherein the set of parameters further comprises at least one of the following:
a secret key used as an input parameter of the rule and for differentiating the first device from a third device associated with the second device,
an identification information pool from which the first identification information and the second identification information are generated based on the rule, or
an activation/deactivation indication for activating or deactivating the first identification information and the second identification information.

61. The first device of claim 60, wherein
the at least one memory storing instructions that, when executed by the at least one processor, further cause the first device to:
transmit, to the second device, a count of the counter encrypted with the secret key.

62. The first device of claim 59,
wherein the generation of the first identification information and the second identification information further comprise:
generate the first identification information based on the rule and the count provided by the counter; and
generate the second identification information based on the rule and the count plus a number.

63. The first device of claim 62, wherein the number is predefined or is configured during a negotiation with the second device for the set of parameters.

64. The first device of claim 60, wherein the generation the first identification information and the second identification information further comprise:
employ the rule with input parameters being at least one of the secret key, the count of the counter, or the identification information pool.

65. A second device comprising:
at least one processor; and
at least one memory storing instructions that, when executed by the at least one processor, cause the second device to:
determine a set of parameters for identification information generation for a first device, the set of parameters being common to the first device and the second device;
generate, based on the set of parameters, third identification information and fourth identification information of the first device;
detect a first transmission from the first device using the third identification information and the fourth identification information; and
transmit, to the first device, a second transmission comprising the third identification information.

66. The second device of claim 65, wherein the set of parameters is determined through a negotiation with the second device during an association of the second device to the first device, the negotiation being initiated by the first device or the second device.

67. The second device of claim 66, wherein the first transmission and the second transmission are of a predefined or pre-configured type.

68. The second device of claim 67, wherein the pre-configured type is determined during the negotiation between the first device and the second device, and the predefined or pre-configured type comprises at least one of the following:
a unicast frame transmission,
a frame transmission in a pre-association phase related to the first device and the second device,
a frame transmission during an association of the first device to the second device,
a management frame transmission,
a control frame transmission, or
a data frame transmission.

69. The second device of claim 65, wherein the detecting of the first transmission further comprises:
compare first identification information of the first device in the first transmission with the third identification information and the fourth identification information; and
based on the comparing that the first identification information matches the third identification information or the fourth identification information, determine that the first transmission is a valid transmission from the first device.

70. The second device of claim 69, wherein
the at least one memory storing instructions that, when executed by the at least one processor, further cause the second device to:
transmit an acknowledgement (ACK) for the first transmission to the first device based on the comparing that the first transmission is a valid transmission from the first device.

71. A method comprising:
determining, at a first device, a set of parameters for identification information generation for the first device, the set of parameters being common to the first device and a second device;
generating, based on the set of parameters, first identification information and second identification information of the first device;
transmitting, to the second device, a first transmission comprising the first identification information; and
detecting a second transmission from the second device using the first identification information and the second identification information.
